(19) United States
(12) Patent Application Publication
(10) Pub. No.: US 2025/0354892 A1
(43) Pub. Date: Nov. 20, 2025

(54) MACHINING TOOL LIFE PREDICTION METHOD

(71) Applicant: BenQ Materials Corporation, Taoyuan City (TW)

(72) Inventor: Kuo Jung HUANG, Taoyuan City (TW)

(21) Appl. No.: 18/813,048

(22) Filed: Aug. 23, 2024

(30) Foreign Application Priority Data
May 20, 2024 (TW) 113118601

(51) Int. Cl. G01M 13/00; G01H 1/00; G05B 19/4065

(52) U.S. Cl. CPC G01M 13/00; G01H 1/00; G05B 19/4065; G05B 2219/37252

(57) ABSTRACT

A machining tool life prediction method includes: establishing a prediction model and inputting an instant vibration signal of a tested machining tool into the prediction model to obtain a health index of the tested machining tool. The prediction model is established by: obtaining plural vibration signals of plural machining tools; utilizing an empirical mode decomposition to obtain plural intrinsic mode functions; analyzing a correlation between each of the intrinsic mode functions and the corresponding wear degree to obtain plural sampling signals; obtaining plural characteristic factors by calculating the sampling signals; utilizing an anomaly score analysis to group the characteristic factors according to the wear degree; and utilizing a variation comparison algorithm to verify a result of the anomaly score analysis and obtaining a health index of each of the machining tools, thereby establishing the prediction model.

### CROSS-REFERENCE TO RELATED APPLICATION

This application claims priority to Taiwan Application Serial Number 113118601, filed May 20, 2024, which is herein incorporated by reference in its entirety.

### BACKGROUND

### Field of Invention

The present disclosure relates to a machining tool life prediction method. More particularly, the present disclosure relates to a machining tool life prediction method that utilizes an anomaly score analysis and a variation comparison algorithm.

### Description of Related Art

A wear degree of a machining tool is highly correlated with a quality of workpiece machining. When the wear degree of the machining tool increases, a cutting resistance significantly increases, resulting in a corresponding increase in a size variation of the workpiece after machining and a surface roughness of the machined surface, thereby affecting the machining quality. Therefore, during manufacturing, the use and the management of the machining tool, or even related technologies such as machining tool life prediction, have become important factors in reducing tool inventory, increasing tool utilization, and improving machining quality.

### SUMMARY

The present disclosure provides a machining tool life prediction method. The machining tool life prediction method includes: establishing a prediction model; and inputting an instant vibration signal of a tested machining tool into the prediction model to obtain a health index of the tested machining tool. The prediction model is established by: obtaining plural vibration signals of plural machining tools when each of the machining tools is utilized to perform a machining operation, in which each of the vibration signals corresponds to a wear degree of each of the machining tools; utilizing an empirical mode decomposition (EMD) to obtain plural intrinsic mode functions (IMF) included in each of the vibration signals; analyzing a correlation between each of the intrinsic mode functions and the corresponding wear degree to obtain plural sampling signals of the machining tools, in which each of the sampling signals is correlated with a life of each of the machining tools; obtaining plural characteristic factors by calculating the sampling signals; utilizing an anomaly score analysis to group the characteristic factors according to the wear degree, thereby grouping the characteristic factors into plural clusters; and utilizing a variation comparison algorithm to verify a result of the anomaly score analysis and obtaining a health index of each of the machining tools, thereby establishing the prediction model.

In accordance with one or more embodiments of the present disclosure, each of the sampling signals is a sum of a first intrinsic mode function and a second intrinsic mode function of each of the machining tools. The first intrinsic mode function is one of the intrinsic mode functions which has a smallest characteristic time scale. The second intrinsic mode function is one of the intrinsic mode functions which has a second smallest characteristic time scale.

In accordance with one or more embodiments of the present disclosure, the first intrinsic mode function and the second intrinsic mode function respectively correspond to a dust collection frequency and a tool cutting frequency when each of the machining tools is utilized to perform the machining operation.

In accordance with one or more embodiments of the present disclosure, the clusters include an initial wear stage, a stable wear stage, and a rapid wear stage.

In accordance with one or more embodiments of the present disclosure, the anomaly score analysis is used to analyze the characteristic factors through an isolation forest (IF) algorithm, a density-based spatial clustering of applications with noise (DBSCAN) algorithm, or a local outlier factor (LOF) algorithm, thereby determining one of the characteristic factors belongs to which one of the clusters.

In accordance with one or more embodiments of the present disclosure, the variation comparison algorithm is a normalized Mahalanobis distance algorithm or a Euclidean distance algorithm.

In accordance with one or more embodiments of the present disclosure, the variation comparison algorithm utilizes a window function to analyze N of the characteristic factors to obtain the health index corresponding to N of the characteristic factors. N of the characteristic factors belong to a same one of the clusters. N is a window length of the window function. N is a natural number. N usage times corresponding to N of the characteristic factors are continuous.

In accordance with one or more embodiments of the present disclosure, the health index of each of the machining tools is a percentage of an average value of N Mahalanobis distances corresponding to N of the characteristic factors.

In accordance with one or more embodiments of the present disclosure, the machining tool life prediction method further includes: performing an importance filtering on the characteristic factors to exclude plural low-importance characteristic factors from the characteristic factors.

In accordance with one or more embodiments of the present disclosure, the importance filtering is based on a sum of a monotonicity and a trendability of each of the characteristic factors. The sum of the monotonicity and the trendability of each of the low-importance characteristic factors is less than a threshold.

In accordance with one or more embodiments of the present disclosure, the characteristic factors are obtained by: performing a time domain feature extraction and a frequency domain feature extraction on each of the sampling signals to obtain the characteristic factors.

In accordance with one or more embodiments of the present disclosure, the machining tool life prediction method further includes: adjusting at least one parameter of a machining apparatus according to a corresponding one of the clusters and the health index of the tested machining tool. The machining apparatus holds the tested machining tool to perform the machining operation.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart of a machining tool life prediction method in accordance with some embodiments of the present disclosure.

FIG. 2 is a simplified flowchart of establishing the machining tool life prediction method in accordance with some embodiments of the present disclosure.

FIG. 3 is a schematic diagram of the training stage and the prediction stage of the machining tool life prediction method in accordance with some embodiments of the present disclosure.

FIG. 4 is an example of utilizing the isolation forest algorithm to group the characteristic factors in accordance with some embodiments of the present disclosure.

FIG. 5 is an example of utilizing the normalized Mahalanobis distance algorithm to obtain the health index in accordance with some embodiments of the present disclosure.

### DETAILED DESCRIPTION

Specific embodiments of the present disclosure are further described in detail below with reference to the accompanying drawings, however, the embodiments described are not intended to limit the present disclosure and it is not intended for the description of operation to limit the order of implementation. The using of “first”, “second”, “third”, etc. in the specification should be understood for identify units or data described by the same terminology, but are not referred to particular order or sequence.

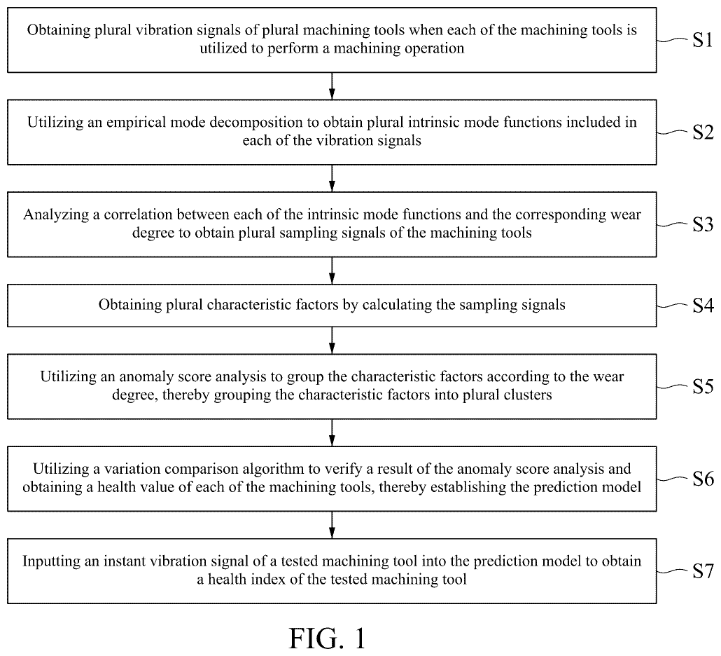

FIG. 1 is a flowchart of a machining tool life prediction method in accordance with some embodiments of the present disclosure. As shown in FIG. 1, the machining tool life prediction method includes steps S1-S7. The steps S1-S6 correspond to a model-establishing stage for establishing a prediction model. The step S7 corresponds to a prediction stage. In the step S1, plural vibration signals respectively correspond to plural machining tools are obtained when each of the machining tools is utilized to perform a machining operation. Each of the vibration signals corresponds to a wear degree of each of the machining tools. Specifically, as the wear degrees of the machining tools are different, the vibration signals of the machining tools are also different. Therefore, the present disclosure acquires the wear degree of each of the machining tools by analyzing the corresponding vibration signals, and thus the machining tool life is also possible to be predicted. In some embodiments of the present disclosure, the vibration signals in step S1 are obtained through a vibration measurement system composed of an acceleration sensor (also called an accelerometer) and a signal acquisition device. The acceleration sensor is attached to each of the machining tools to measure the vibration signal of each of the machining tools when each of the machining tools is utilized to perform the machining operation. The signal acquisition device communicates with the acceleration sensor and the computing unit (such as a computer) to convert each of the vibration signals from an analog signal into a digital signal and transmit the digital signal to the computing unit.

In the step S2, an empirical mode decomposition (EMD) is utilized to obtain plural intrinsic mode functions (IMFs) included in each of the vibration signals. Specifically, each of the vibration signals includes the intrinsic mode functions. In the step S3, a correlation between each of the intrinsic mode functions and the corresponding wear degree is analyzed to obtain plural sampling signals. Each of the sampling signals is correlated with a life of each of the machining tools. Specifically, the steps S2 and S3 correspond to pre-processed steps and are used to reduce signal noise to improve the accuracy of the machining tool life prediction method of the present disclosure.

In detail, the step S2 performs the empirical mode decomposition on each of the vibration signals to separate plural intrinsic mode functions from each of the vibration signals. In detail, the step S3 extracts the first intrinsic mode function and the second intrinsic mode function from the intrinsic mode functions, and adds the first intrinsic mode function and the second intrinsic mode function to obtain the sample signal. The first intrinsic mode function is one of the intrinsic mode functions which has the smallest characteristic time scale. The second intrinsic mode function is one of the intrinsic mode functions which has the second smallest characteristic time scale. In other words, each of the sampling signals is a sum of the first intrinsic mode function and the second intrinsic mode function. In other words, through the steps S2 and S3, one sampling signal may be obtained from the corresponding one vibration signal of the corresponding one machining tool. Therefore, plural sampling signals may be obtained from plural vibration signals of plural machining tools. Specifically, because the vibration signal of the machining tool is correlated with the wear degree of the machining tool, the sampling signal obtained from the vibration signal is also correlated with the wear degree of the machining tool. In other words, the sampling signal is correlated with the life of the machining tool.

Specifically, the empirical mode decomposition in the step S2 decomposes the vibration signal to obtain a limited number of intrinsic mode functions. The intrinsic mode functions contain different characteristic time scales.

That is, the characteristics of the vibration signal at different characteristic time scales will be exhibited at different resolution, and thus the empirical mode decomposition has multi-resolution characteristics. In some embodiments of the present disclosure, during the decomposing process of the empirical mode decomposition, the intrinsic mode function with the smallest characteristic time scale (also be the highest frequency signal and also be the signal with the largest amplitude) in the vibration signal is separated, and then the intrinsic mode function with the second smallest characteristic time scale is separated, and so on. Finally, the intrinsic mode function with the largest characteristic time scale (also be the lowest frequency signal and also be the signal with the smallest amplitude) is separated.

In some embodiments of the present disclosure, the first intrinsic mode function and the second intrinsic mode function respectively correspond to the dust collection frequency and the tool cutting frequency when the machining tool is utilized to perform the machining operation. Specifically, the present disclosure utilizes the bandpass filtering characteristics of the empirical mode decomposition. The structural resonance frequency band is located within a specific intrinsic mode function, and thus the corresponding intrinsic mode function may be selected to effectively determine the machining tool life. The above-mentioned dust collection frequency and tool cutting frequency are considered to be the most important frequencies that determine the machining tool life. In other words, the first intrinsic mode function and the second intrinsic mode function are highly correlated with the wear degree of the machining tool. For example, the dust collection frequency corresponding to the first intrinsic mode function is correlated with the amount of cutting dust generated by the machining tool after machining the object to be machined, and the tool cutting frequency corresponding to the second intrinsic mode function is correlated with the number of times that the machining tool directly contacts the object to be machined. Therefore, the first intrinsic mode function and the second intrinsic mode function are highly correlated with the wear degree of the machining tool after contacting with the object to be machined.

The advantage of the empirical mode decomposition is that the original signal may be decomposed without pre-analysis and/or pre-research, and the original signal is decomposed from high frequency to low frequency until the residual signal is decomposed. The present disclosure utilizes the advantage of the empirical mode decomposition to extract only the discomposed high-frequency signals (i.e., the dust collection frequency signal and the tool cutting frequency signal) and utilize the high-frequency signals to replace the original vibration signal as testing data and/or training data for the prediction model.

Specifically, the present disclosure utilizes the empirical mode decomposition to remove noise and less important frequency signals (i.e., noise reduction pre-processing), and only utilizes the dust collection frequency signal and the tool cutting frequency signal for subsequent analysis, replacing the traditional full-bandwidth analysis, thereby reducing the amount of calculations and effectively improving the accuracy of the prediction model.

In addition, before performing the step S2, because the vibration signals obtained in the step S1 may contain invalid signals resulting in inconsistent signal amplitudes at the head end and/or tail end of the vibration signal, the present disclosure may further perform a simple noise removal process on the vibration signals (such as removing the inconsistent signal amplitude at the head end and/or the tail end of the signal) to remove the invalid signals from the vibration signals, thereby obtaining the real data of the vibration signals.

In the step S4, plural characteristic factors are obtained by calculating the sampling signals. In some embodiments of the present disclosure, the step S4 performs a feature extraction on the sampling signal. The feature extraction includes a time domain feature extraction and a frequency domain feature extraction. In other words, the characteristic factors in the step S4 include the time domain characteristic factors and the frequency domain characteristic factors. In other words, the step S4 performs the time domain feature extraction and the frequency domain feature extraction on each of the sampling signals to obtain the characteristic factors.

The time domain feature extraction may be achieved through a simple statistical calculation, such as mean, standard deviation, root mean square, skewness, variance, kurtosis, peak, peak to peak, crest factor, shape factor, impulse factor, margin factor, and/or clearance factor.

The frequency domain feature extraction may improve the identification effect of features. For example, the long-term trend of the cutting number in the full frequency domain according to the machining tool life may be obtained in the following manner. Frequency domain feature value extraction may, for example, calculate the accumulated value of the cutting numbers corresponding to the frequency range from 0 to 25 KHz, and with frequency interval of 200 Hz.

It is worth mentioning that after the characteristic factors are obtained from each of the sampling signals in the step S4, the upper and lower ranges of the characteristic factors may be greatly different due to the different units used in the calculation process. Therefore, a normalization manner may be utilized to adjust the upper and lower limits of the characteristic factors to between 0 and 1, thereby improving the learning and prediction efficiency of the prediction model.

In some embodiments of the present disclosure, in the step S4, an importance filtering may further be performed on the characteristic factors corresponding to each of the sampling signals, thereby excluding plural low-importance characteristic factors from the characteristic factors. The importance filtering is based on a sum of a monotonicity and a trendability of each of the characteristic factors. The sum of the monotonicity and the trendability of each of the low-importance characteristic factors is less than a threshold. In other words, the importance filtering acquires the sum of the monotonicity and the trendability of each of the characteristic factors, and then defines some of the characteristic factors whose sum of the monotonicity and the trendability is lower than a threshold as the low-importance characteristic factors. In some embodiments of the present disclosure, the importance filtering is performed on the following time domain features extracted from the time domain feature extraction: mean, standard deviation, root mean square, skewness, variance, kurtosis, peak, peak to peak, crest factor, shape factor, impulse factor, margin factor, and/or clearance factor.

Specifically, the time domain features essentially have their own differences in importance. The importance filtering is basically to rank the time domain features by importance, thereby quantifying the importance of each of the time domain features. The importance filtering is utilized to acquire highly-indicative time domain features. The importance filtering may make the characteristic factors as easy to be distinguished as possible, and thus the importance filtering is very helpful for model simplification and reduction of calculation time. The monotonicity is obtained by calculating the monotonicity value separately for each time domain feature extraction method, and thus the monotonicity is a fixed value. The trendability is obtained by calculating the minimum absolute correlation number between the time domain feature and all other time domain features, and thus the trendability change as the number or the form of the time domain features changes. The value of each of the monotonicity and trendability is between 0 and 1. The higher the value of each of the monotonicity and trendability, the higher the performance of the corresponding time domain characteristic index in exhibiting the deterioration trend of the wear degree of the machining tool. In some embodiments of the present disclosure, the sum of the monotonicity and the trendability is used as a feature importance indicator.

The importance filtering adds the monotonicity and the trendability of each of the characteristic factors, and then compares the sum of the monotonicity and the trendability with a threshold (e.g., 0.5), and then defines some of the characteristic factors whose sum of the monotonicity and the trendability is lower than the threshold as the low-importance characteristic factors.

In the step S5, an anomaly score analysis is utilized to group the characteristic factors according to the wear degree, thereby grouping the characteristic factors into plural clusters. In some embodiments of the present disclosure, the anomaly score analysis is used to analyze the characteristic factors through an isolation forest (IF) algorithm, a density-based spatial clustering of applications with noise (DBSCAN) algorithm, or a local outlier factor (LOF) algorithm, thereby determining one of the characteristic factors belongs to which one of the clusters. For example, the step S5 groups the characteristic factors through the isolation forest algorithm to classify the characteristic factors into plural clusters.

In some embodiments of the present disclosure, the clusters include an initial wear stage, a stable wear stage, and a rapid wear stage. In other words, in the step S5, the characteristic factors are classified into three clusters (i.e., the initial wear stage, the stable wear stage, and the rapid wear stage) through the anomaly score analysis. In addition, the anomaly score analysis is further performed on some of the characteristic factors which belong to the same cluster, thereby evaluating the anomaly level corresponding to the some of the characteristic factors which belong to the same cluster.

The initial wear stage is a first stage that the machining tool is worn. In initial wear stage, the surface of the machining tool is subject to greater stress, and the machining tool is worn faster at this time. The stable wear stage is a second stage that the machining tool is worn. The wear rate decreases at the stable wear stage, and the stable wear stage is also a stage with the best work efficiency and machining quality. The rapid wear stage is a third stage that the machining tool is worn. In the rapid wear stage, the machining tool becomes blunt, the cutting force increases, and the wear amount increases sharply. The results of the anomaly score analysis show that there are significant differences in the anomaly scores of these three clusters (i.e., the initial wear stage, the stable wear stage, and the rapid wear stage). As the wear degree of machining tool increases, the anomaly score of one of the stable wear stage and the rapid wear stage is higher than the anomaly score of the initial wear stage.

Specifically, different from the classified predicting algorithms such as the machine learning algorithm or the deep learning algorithm, the present disclosure adopts an unsupervised learning algorithm (i.e., the anomaly score analysis, such as the isolated forest algorithm). The advantage of the isolated forest algorithm is the high efficiency of massive data processing and the fast calculation speed. The isolated forest algorithm is suitable for anomaly detection of continuous data (i.e., the isolation forest algorithm isolates outliers from all samples). The isolated forest algorithm defines points that are sparsely distributed in the data space and far away from dense groups as anomaly. Finally, the anomaly score may be used to evaluate how far data points are from the normal data, so as to achieve the purpose of data grouping. The targets of the grouping processing are outliers in continuous structured data, and then the outliers are separated. Therefore, the characteristic factors are grouped into three clusters (i.e., the initial wear stage, the stable wear stage, and the rapid wear stage), and then the abnormal score analysis is used to evaluate how far data points are from the normal data.

In the step S6, a variation comparison algorithm is utilized to verify a result of the anomaly score analysis in the step S5, and then a health index of each of the machining tools is obtained, thereby establishing the prediction model. In some embodiments of the present disclosure, the variation comparison algorithm is a normalized Mahalanobis distance algorithm or a Euclidean distance algorithm.

Specifically, the variation comparison algorithm (such as the normalized Mahalanobis distance algorithm) utilizes a window function to analyze N (e.g., N=10, and the window function is utilized to obtain an average of 10 sample points) of the characteristic factors which belong to a same one of the clusters, thereby obtaining the health index corresponding to N of the characteristic factors which belong to the same one of the clusters. N is a window length of the window function. N usage times (number of using the machining tool) corresponding to N of the characteristic factors which belong to the same one of the clusters are continuous, such as the number of using the machining tool from i to i+N−1, in which i and N are natural numbers. In other words, the normalized Mahalanobis distance algorithm uses every N sample points (e.g., every 10 sample points) as a window function to calculate the health index.

Specifically, the normalized Mahalanobis distance algorithm uses the homogeneity or heterogeneity between the data points to calculate the distances between the data points. The normalized Mahalanobis distance algorithm is used to evaluate the distance between two sample points. In addition to the distance, the distribution of the reference group is also considered. Finally, the result of the normalized Mahalanobis distance algorithm is used as a comprehensive evaluating index (i.e., the health index or the remaining life) to evaluate the remaining life of the machining tool (all called the health index).

In some embodiments of the present disclosure, the health index of each of the machining tools is a percentage of an average value of N Mahalanobis distances corresponding to N of the characteristic factors. For example, the normalized Mahalanobis distance algorithm uses a window function to analyze N of the characteristic factors which belong to the same cluster (e.g., N=10, and the window function is utilized to obtain an average of 10 sample points), and then the average of these N sample points*100% (for example, the average of 10 sample points*100%) can be used to obtain the health index.

Specifically, the step S6 utilizes the variation comparison method (such as the normalized Mahalanobis distance algorithm) to verify the grouping result of the anomaly score analysis (such as the isolated forest algorithm) in the step S5, and the verifying result and the grouping result need to be consistent, such that the selected sampling signals and their characteristic factors are reliable and representative of the wear degree.

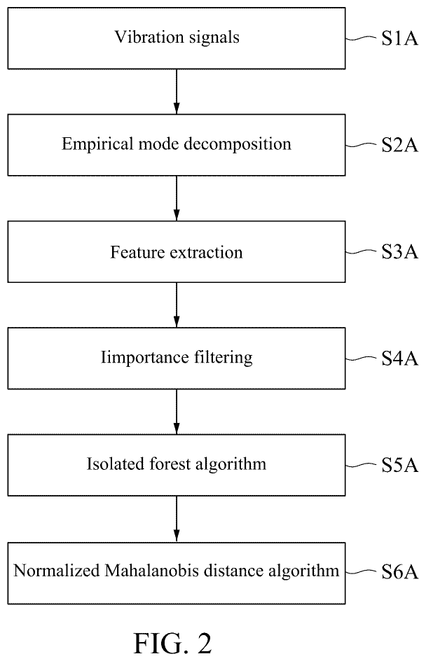

FIG. 2 is a simplified flowchart of establishing the machining tool life prediction method in accordance with some embodiments of the present disclosure. The vibration signals in step S1A of FIG. 2 correspond to the step S1 in FIG. 1, in which the vibration signals of the machining tools are obtained when each of the machining tools is utilized to perform the machining operation. The empirical mode decomposition in step S2A of FIG. 2 corresponds to the step S2 in FIG. 1, in which the empirical mode decomposition is utilized to obtain the intrinsic mode functions included in each of the vibration signals. The feature extraction in step S3A of FIG. 2 corresponds to the step S4 in FIG. 1, in which feature extraction is performed on each of sampling signals to obtain the characteristic factors from each of sampling signals. The importance filtering in step S4A of FIG. 2 corresponds to the above-mentioned importance filtering for the characteristic factors corresponding to each of the sampling signals. The isolated forest algorithm in step S5A of FIG. 2 corresponds to the step S5 in FIG. 1, in which the abnormal score analysis (e.g., the isolated forest algorithm) is utilized to group the characteristic factors according to the wear degree, thereby grouping the characteristic factors into the clusters. The normalized Mahalanobis distance algorithm in step S6A of FIG. 2 corresponds to the step S6 of FIG. 1, in which the variation comparison method (e.g., the normalized Mahalanobis distance algorithm) is utilized to verify the result of the anomaly score analysis, and the health index of each of the machining tools is obtained, thereby establishing the prediction model.

As shown in FIG. 1, in the step S7, an instant vibration signal of a tested machining tool when the tested machining tool is utilized to perform a machining operation is inputted into the prediction model, thereby obtaining a health index of the tested machining tool. Specifically, the steps S1 to S6 belong to the model-establishing/training stage of the machining tool life prediction method. The step S7 belongs to the prediction stage of the machining tool life prediction method.

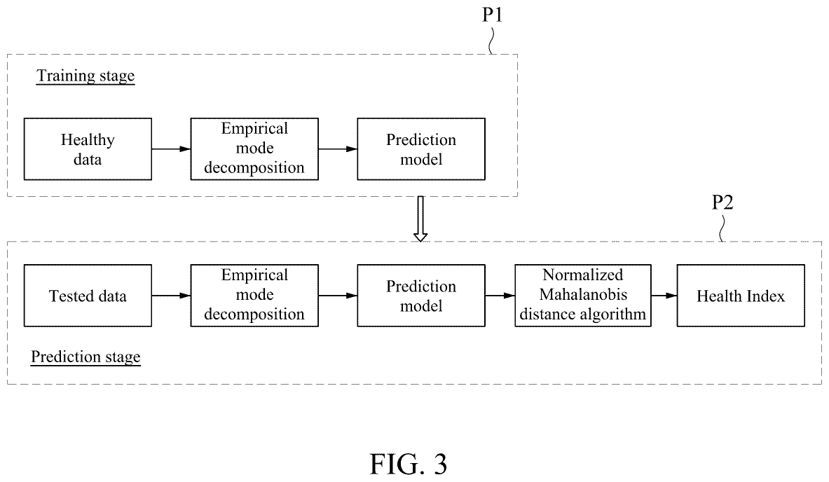

In other words, the machining tool life prediction method of the present disclosure further includes a training stage in the model-establishing stage of the steps S1 to S6. In the training stage, the training data is inputted into the prediction model that has not yet been trained, thereby training the prediction model. In the prediction stage of the step S7 of the machining tool life prediction method of the present disclosure, the tested data is inputted into the trained prediction model to predict the health index (i.e., the remaining life of the machining tool). FIG. 3 is a schematic diagram of the training stage P1 and the prediction stage P2 of the machining tool life prediction method in accordance with some embodiments of the present disclosure. As shown in FIG. 3, in the training stage P1, when each of plural new machining tools is utilized to perform the machining operation, plural healthy vibration signals (represented by health data in FIG. 3, and for example, 400 health data) corresponding to the new machining tools are obtained. Therefore, these healthy vibration signals correspond to the vibration signals of the initial wear stage of the machining tools. Then, the empirical mode decomposition is utilized to obtain plural intrinsic mode functions included in each of the vibration signals. Then, the correlation between each of the intrinsic mode functions and the corresponding wear degree is analyzed to obtain plural sampling signals of the machining tools, in which the sampling signal are correlated with the life of the machining tools. Then, plural characteristic factors are obtained by calculating the sampling signals. Herein, these characteristic factors are called plural training signals respectively corresponding to the healthy vibration signals. Finally, the training signals are inputted into the prediction model that has not yet been trained, thereby training the prediction model. And then, in the prediction stage P2, the machining tool life prediction method of the present disclosure performs a series of data processing on the instant vibration signal (represented by the tested data in FIG. 3) of the tested machining tool when the tested machining tool is utilized to perform the machining operation to obtain the health index corresponding to the instant vibration signal of the tested machining tool.

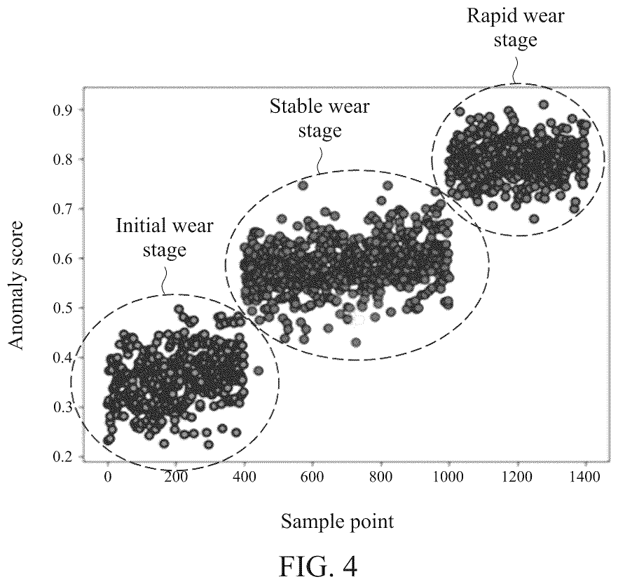

Regarding the step S5, the isolation forest algorithm is utilized to group the characteristic factors into the clusters: the initial wear stage, the stable wear stage, and the rapid wear stage. FIG. 4 shows the example measurement result that the step S5 performs the anomaly score analysis on some of the characteristic factors which belong to the same cluster. As shown in FIG. 4, the machining tool life prediction method of the present disclosure may successfully group the characteristic factors (represented by the sample points in FIG. 4).

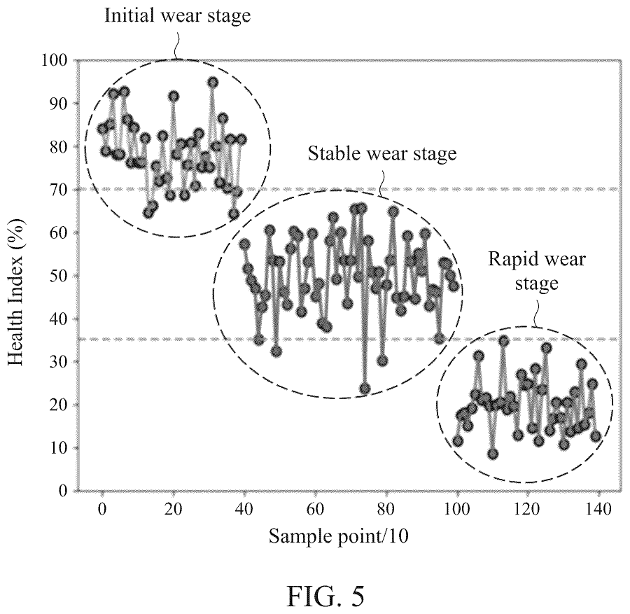

FIG. 5 shows the example measurement result that the step S6 utilizes the normalized Mahalanobis distance algorithm to verify the result of the anomaly score analysis and obtains the health index corresponding to each of the machining tools. As shown in FIG. 5, the normalized Mahalanobis distance algorithm is utilized and every 10 sample points are used as a window function to calculate the health index. The health index of the machining tools corresponding to the initial wear stage is about 70% to 100%. The health index of the machining tools corresponding to the stable wear stage is about 40% to 70%. The health index of the machining tools corresponding to rapid wear stage is about 20% to 30%. Therefore, the machining tool life prediction method of the present disclosure may achieve the prediction and evaluation of the remaining life (i.e., health index) of the tested machining tool.

In addition, the machining tool life prediction method of the present disclosure may further, after the step S7, adjusts at least one parameter of a machining apparatus during the machining operation is performed according to the corresponding one of the clusters and the health index of the tested machining tool which are obtained by the prediction model. The machining apparatus holds the tested machining tool to perform the machining operation. For example, the first intrinsic mode function and the second intrinsic mode function may be analyzed to adjust at least one parameter of the machining apparatus. For example, after utilizing the empirical mode analysis, the first intrinsic mode function and the second intrinsic mode function are analyzed to determine that the tool cutting frequency of the second intrinsic mode function is abnormal. After the inspection by the operator, it was found that the resonance of the turret was abnormal, so that the corresponding parameter of the turret is adjusted to be optimized. According to actual experiments, after adjusting the corresponding parameter of the turret of the machining apparatus, the machining tool life was increased by about 67%.

To sum up, the present disclosure provides the machining tool life prediction method, which can predict the health index (i.e., the remaining life) of the tested machining tool with better accuracy, so as to reduce the storage amount of the machining tools, improve the utilization rate of the machining tools, and improve the machining quality of the machining tools.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A machining tool life prediction method, comprising:
establishing a prediction model; and
inputting an instant vibration signal of a tested machining tool into the prediction model to obtain a health index of the tested machining tool;
wherein the prediction model is established by:
obtaining a plurality of vibration signals of a plurality of machining tools when each of the machining tools is utilized to perform a machining operation, wherein each of the vibration signals corresponds to a wear degree of each of the machining tools;
utilizing an empirical mode decomposition to obtain a plurality of intrinsic mode functions included in each of the vibration signals;
analyzing a correlation between each of the intrinsic mode functions and the corresponding wear degree to obtain a plurality of sampling signals of the machining tools, wherein each of the sampling signals is correlated with a life of each of the machining tools;
obtaining a plurality of characteristic factors by calculating the sampling signals;
utilizing an anomaly score analysis to group the characteristic factors according to the wear degree, thereby grouping the characteristic factors into a plurality of clusters; and
utilizing a variation comparison algorithm to verify a result of the anomaly score analysis and obtaining a health index of each of the machining tools, thereby establishing the prediction model.

2. The machining tool life prediction method of claim 1, wherein each of the sampling signals is a sum of a first intrinsic mode function and a second intrinsic mode function of each of the machining tools, wherein the first intrinsic mode function is one of the intrinsic mode functions which has a smallest characteristic time scale, wherein the second intrinsic mode function is one of the intrinsic mode functions which has a second smallest characteristic time scale.

3. The machining tool life prediction method of claim 2, wherein the first intrinsic mode function and the second intrinsic mode function respectively correspond to a dust collection frequency and a tool cutting frequency when each of the machining tools is utilized to perform the machining operation.

4. The machining tool life prediction method of claim 1, wherein the clusters include an initial wear stage, a stable wear stage, and a rapid wear stage.

5. The machining tool life prediction method of claim 1, wherein the anomaly score analysis is used to analyze the characteristic factors through an isolation forest (IF) algorithm, a density-based spatial clustering of applications with noise (DBSCAN) algorithm, or a local outlier factor (LOF) algorithm, thereby determining one of the characteristic factors belongs to which one of the clusters.

6. The machining tool life prediction method of claim 1, wherein the variation comparison algorithm is a normalized Mahalanobis distance algorithm or a Euclidean distance algorithm.

7. The machining tool life prediction method of claim 1, wherein the variation comparison algorithm utilizes a window function to analyze N of the characteristic factors to obtain the health index corresponding to N of the characteristic factors, wherein N of the characteristic factors belong to a same one of the clusters, wherein N is a window length of the window function, wherein N is a natural number, wherein N usage times corresponding to N of the characteristic factors are continuous.

8. The machining tool life prediction method of claim 7, wherein the health index of each of the machining tools is a percentage of an average value of N Mahalanobis distances corresponding to N of the characteristic factors.

9. The machining tool life prediction method of claim 1, further comprising:
performing an importance filtering on the characteristic factors to exclude a plurality of low-importance characteristic factors from the characteristic factors.

10. The machining tool life prediction method of claim 9, wherein the importance filtering is based on a sum of a monotonicity and a trendability of each of the characteristic factors, wherein the sum of the monotonicity and the trendability of each of the low-importance characteristic factors is less than a threshold.

11. The machining tool life prediction method of claim 1, wherein the characteristic factors are obtained by:
performing a time domain feature extraction and a frequency domain feature extraction on each of the sampling signals to obtain the characteristic factors.

12. The machining tool life prediction method of claim 1, further comprising:
adjusting at least one parameter of a machining apparatus according to a corresponding one of the clusters and the health index of the tested machining tool, wherein the machining apparatus holds the tested machining tool to perform the machining operation.
